(19) United States
(12) Patent Application Publication
(10) Pub. No.: US 2014/0055369 A1
(43) Pub. Date: Feb. 27, 2014

(54) SINGLE-GESTURE MOBILE COMPUTING DEVICE OPERATIONS

(71) Applicant: Xintian Li, Santa Clara, CA (US)

(72) Inventor: Xintian Li, Santa Clara, CA (US)

(73) Assignee: QUALCOMM INNOVATION CENTER, INC., San Diego, CA (US)

(21) Appl. No.: 13/592,118

(22) Filed: Aug. 22, 2012

(51) Int. Cl. G06F 3/0488

(52) U.S. Cl. CPC G06F 3/0488
USPC 345/173

(57) ABSTRACT

A mobile computing device comprising a user interface and a touch button. A mobile computing device operation is adapted to occur upon the touch button being engaged with a touching device and the touching device sliding to the user interface prior to removing the touching device from the mobile computing device.

### BACKGROUND OF THE INVENTION

1. Field of the Invention

This invention is related to mobile computing devices. Specifically, but not intended to limit the invention, embodiments of the invention are related to performing operations on a mobile computing device with a single user movement.

2. Relevant Background

Many mobile computing devices comprise a mobile computing device casing having two buttons. The two buttons may be referred to as a power button and a touch button/home button. On many mobile computing devices the power button may support two separate button operations: a quick-press operation and a press-and-hold operation. A quick-press operation may comprise setting the mobile computing device to a mode of operation such as, but not limited to, setting the mobile computing device to a stand-by operation mode. The press-and-hold operation may also set the mobile computing device to a mode of operation such as, but not limited to, setting the mobile computing device to a power-up or a power-down mode of operation. Similarly, the home button may support one more operations. For example, the home button may support a double-press operation and a single-press operation. The double-press operation, for example, may trigger a task panel.

When a mobile computing device is in standby mode a user may need to press the power button and then another touch gesture on the mobile computing device to unlock the display. On one mobile computing device, a user may press the power button or the home button and then perform another touch gesture to unlock the display or set the mobile computing device to a different mode of operation. Such gestures may include a gesture on the user interface. Therefore, at least two user gestures are contemplated to change a mode of operation on current mobile computing devices.

### SUMMARY OF THE INVENTION

In order to enable a user to more easily change a mode of operation of a mobile computing device, a device, system and method were develop to enable a mobile computing device user to change a mobile computing device mode of operation with a single gesture. Such a device, system and method decreases the time required to change operation modes, simplifies operation mode control and improves the user experience. Furthermore, discussed below is a device, system and method enabling a user to use a single-gesture and/or a gesture comprising a single button to perform operations on a mobile computing device, thereby limiting the need for multiple buttons on mobile computing devices and lowering the cost for developing and/or manufacturing a mobile computing device.

One embodiment of such an invention comprises a mobile computing device. One mobile computing device comprises a user interface and a touch button. A mobile computing device operation is adapted to occur upon the touch button being engaged with a touching device and the touching device sliding to the user interface prior to removing the touching device from the mobile computing device.

Another embodiment of the invention comprises a computing system. One computing system comprises a means for engaging a touch button on mobile computing device with a touching device, a means for sliding the touching device from the touch button to a mobile computing device user interface, and a means for changing an operation mode of the mobile computing device.

And another embodiment of the invention comprises a method of changing an operation mode of a mobile computing device. One method comprises engaging a mobile computing device touch button with a touching device and sliding the touching device to an icon displayed on a user interface. The method may further comprise removing the touching device from the user interface. The operation mode of the mobile computing device may then be changed upon removal of the touching device from the user interface.

Yet another embodiment of the invention comprises a non-transitory, tangible computer readable storage medium, encoded with processor readable instructions to perform a method of changing a mobile computing device mode of operation. One method may comprise engaging a touch button on a mobile computing device with the touch button being located on a top surface of a mobile computing device. Upon engaging the touch button, a user may slide his or her finger from the touch button to an icon displayed on a mobile computing device user interface. The method may further comprise removing the finger from the user interface, which may cause the mobile computing device to change from a first mode of operation to a second mode of operation.

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

### BRIEF DESCRIPTION ON THE DRAWINGS

FIG. 1 illustrates a block diagram depicting components of a computing device;

FIG. 2 illustrates a block diagram of a computing system illustrating communication between a computing device and a network device;

FIG. 3 illustrates a flowchart that depicts a method that may be carried out in connection with the embodiments described herein; and

FIG. 4 illustrates a block diagram depicting components of a computing device.

### DETAILED DESCRIPTION

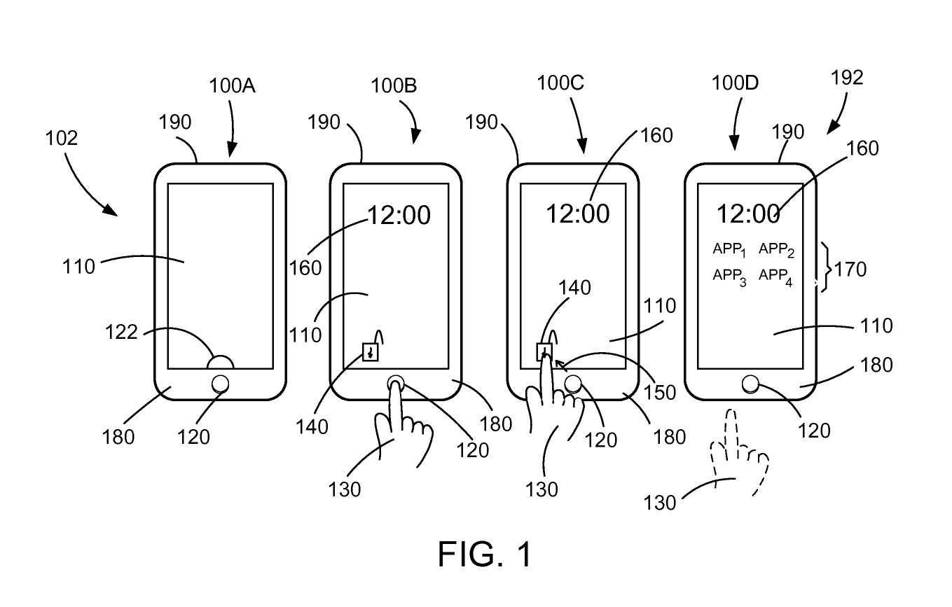

Referring firs to FIG. 1, seen are four images of a mobile computing device 100A, 100B, 100C, 100D. For clarity, when referring to the mobile computing device 100 the element number of 100 may be used. Each image of the mobile computing device 100 displayed in FIG. 1 comprise a user interface 110 and a touch button 120. The user interface 110 may comprise a touch screen. Mobile computing device 100A comprises a mobile computing device 100A in a standby mode of operation. A standby mode of operation may comprise an operation mode where the mobile computing device 100A is powered on, one or more features of the mobile computing device 110A are not accessible. For example, the touch screen may be deactivated during a standby mode. In one embodiment, the mobile computing device 100A may comprise a ring 122. The ring 122 may alert a user to access a specific area of the user interface 110. For example, the ring 122 may highlight one or more of the icons 140 mentioned below before, after, or during when a touching device 130 accesses the icon 140.

Mobile computing device 100B shows a touching device 130 engaging the touch button 120. In one embodiment the touching device 130 may be a person's finger and the person's finger may engage the touch button 120 through pressing the button. Also seen on the mobile computing device 100B is an icon 140. The icon 140 may be displayed upon engaging the touch button 120 by the touching device 130. In one embodiment, the icon may be referred to as a soft key. Also displayed may be, for example a device time 160 or other user interface features.

Mobile computing device 100C shows the touching device 130 placed over the icon 140. In moving from the touch button 120 location seen in mobile computing device 100B to the icon location seen in mobile computing device 100C, the touching device 130 may substantially travel along a direction 150 seen on the mobile computing device 100C. It is contemplated that upon engaging the touch button 120, the touching device may be moved along the direction 150 prior to removal of the touching device 130 from the mobile computing device 130. For example, a person may slide his or her finger along the direction 150 after pressing the touch button 120, but without lifting his or her finger from the mobile computing device 100C. Upon reaching the icon 140, the touching device 130 may be removed from the icon 140, which may unlock the user interface 110, allowing a user to access one or more device features 170 such as, but not limited to, device applications and/or settings. Furthermore, the icon 140 may be removed from the display in on embodiment. However, it is also contemplated that in one embodiment, the icon 140 may be continued to be displayed on the mobile computing device 100D after removing the finger 130 from the icon 140. In such a manner, the operating mode of mobile computing device 100A, 100D may be modified from a standby mode 102 to a wake-up mode 192. Other mobile computing device operations may be initiated with such a, or with a similar, gesture.

It is contemplated that one user interface 110 may comprise a screen. In one embodiment, the screen comprises a first planar surface. Furthermore, the mobile computing device 100 may comprise a top surface 180. In one embodiment, the top surface 180 may comprise the portion of a face of the mobile computing device 100, as seen in FIG. 1, between the user interface 110 and a mobile computing device edge 190. However the top surface 180 may comprise a different portion of the mobile computing device 100. For example, the top surface may only comprise a portion of the face of the mobile computing device 100 between the user interface 11 and the edge 190. In any event, one top surface 180 may comprise a second planar surface and the second planar surface may be located on a substantially similar plane as the first planar surface.

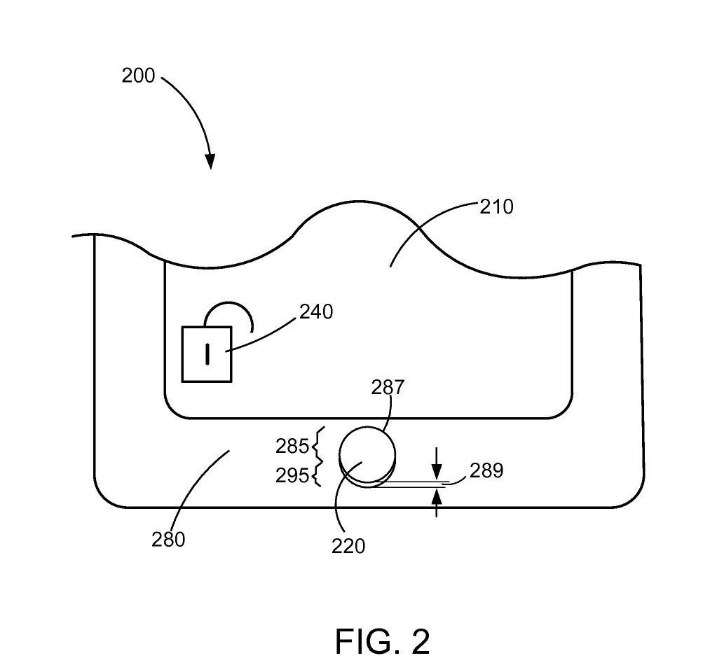

Furthermore, and as seen in FIG. 2, it is contemplated that one mobile computing device 200 may comprise a top surface 280 and user interface 210 comprise a first planar surface and a second planar surface, respectively. In one embodiment, a top portion 285 of the touch button 220 may comprise a third planar surface, the third planar surface being on a substantially similar plane as the first and second planar surface. However, a bottom portion 295 of the button 220 may comprise a button edge 287 having a raised portion of a height 289 adapted to enable a user to quickly feel the edge and locate the bottom potion 295 of the touch button 220. The height 289 may comprise a fourth planar surface having being different from the first, second, and/or third planar surface. The height may also comprise about a 1 mm-10 mm raise section of the edge 287. In one embodiment, at least a portion of the edge may comprise a polymeric material. The height 289 may enable the user to move the touching device 130 to the proper location on the user interface 210 so that the touching device 130 may be placed over the icon 240 without the need to look at the mobile computing device 200 while moving the touching device 230. As seen in FIG. 2, the touch button 220 may be substantially surrounded by the top surface 280.

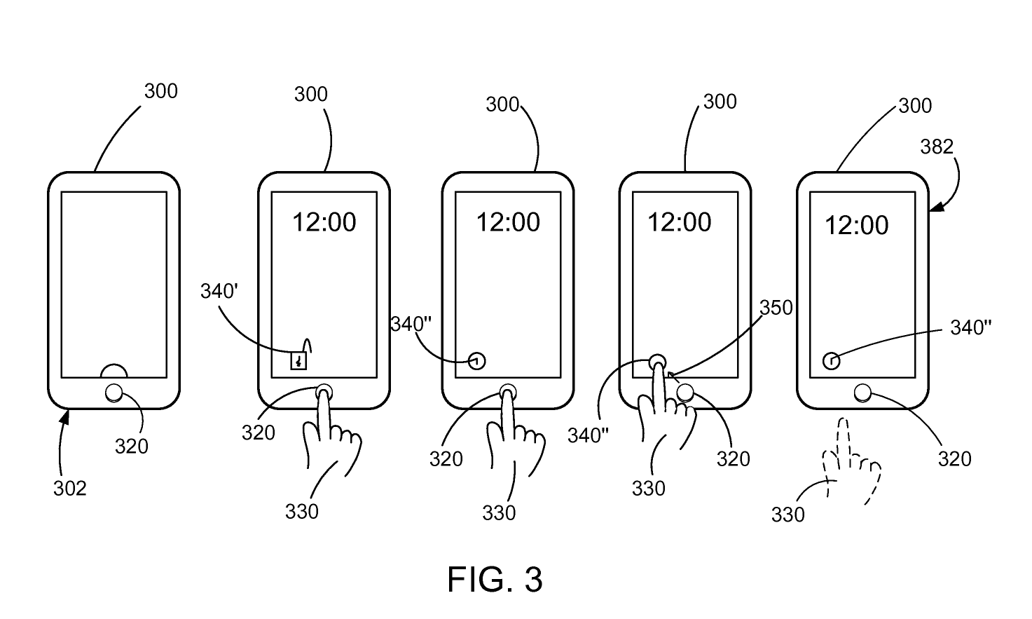

Seen in FIG. 3 is a mobile computing device mode of operation change from a standby mode 302 to a power down mode 382. Similar to changing the mode of operation from the standby mode 102 to the wake-up mode 192 seen in FIG. 1, changing a mode of operation for a mobile computing device 300 from standby mode 302 to power down mode 382 may comprise engaging the touch button 320 with a touching device 330, moving the touching device 330 to the icon 340 and subsequently removing the touching device 330 from the icon 340. However, the icon 340 in FIG. 3 may change from a first icon 340′ to a second icon 340″. In one embodiment, such an icon change may occur upon engaging the touch button 320 for a predetermined period of time. For example, if the touch button 320 is engaged for at least 3s, the icon 340 may change from the first icon 340′ to the second icon 340″. Shorter and longer periods of engaging the touch button 320 to enable a change in the icon 340 are contemplated. For example a 1s or a 5s engagement of the touch button 320 are contemplated. Additionally, in one embodiment, the first icon 340 may comprise an image of a locked or an unlocked padlock, while the second icon 340″ may be a power button icon, as seen in FIG. 3. Upon the icon 340 changing to the second icon 340″, when the touching device 330 is removed from the icon 340″ after sliding to the icon 340″ along the direction 350 and prior to removal of the touching device 330 from the mobile computing device 300, the mobile computing device 300 mode of operation is changed to the power down mode 382 in one embodiment. One power down mode may comprise a process where power is removed from the mobile computing device 300 until a power-up mode is initiated.

The mobile computing device 300 may change from the wake-up mode 192 as seen in FIG. 1 to the power down mode 383 in a similar manner. For example, upon pressing the touch button 320 when the mobile computing device 300 is in a wake-up mode 192, if the touch button 320 is engage for the predetermined period of time, the icon 340 may change from the first icon 340′ to the second icon 340″. Other steps disclosed to change the mode of the mobile computing device 300 may also be similar to those disclosed in the specification.

The mode of the mobile computing device 100 may change from the wake-up mode 192 to the stand-by mode 102 by, for example, pressing the touch button for a period of time less than the predetermine time when the mobile computing device is in the wake-up mode 192 and sliding the touching device 130 to the icon 140 before the icon changes. The touching device 130 is then removed from the mobile computing device 100, thereby initiating the stand-by mode 102. In one embodiment, the user interface 110 during the stand-by mode 102 is locked.

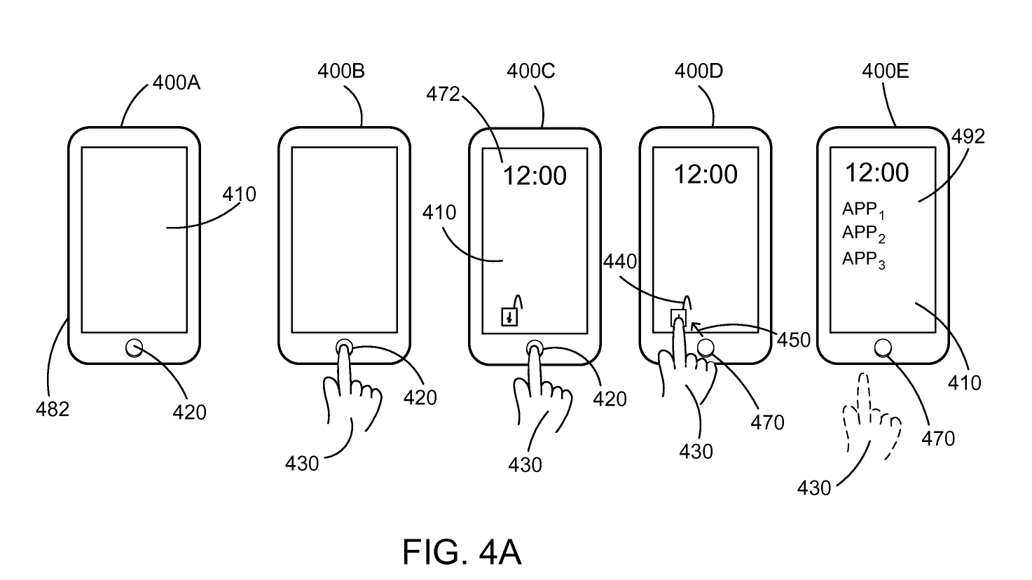

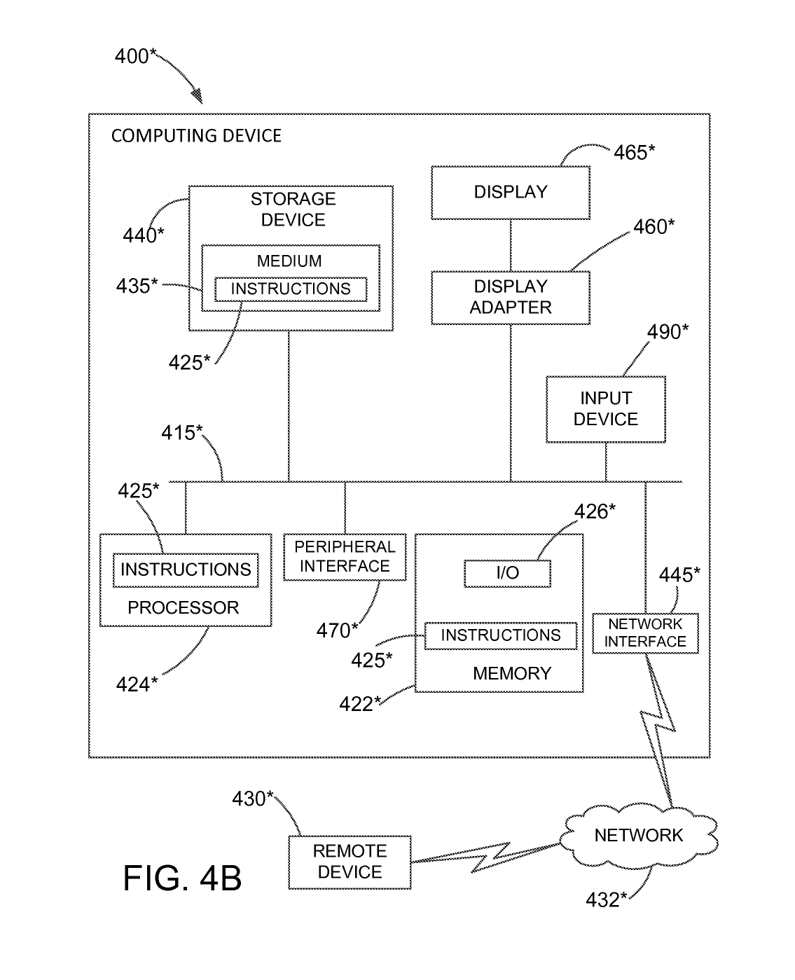

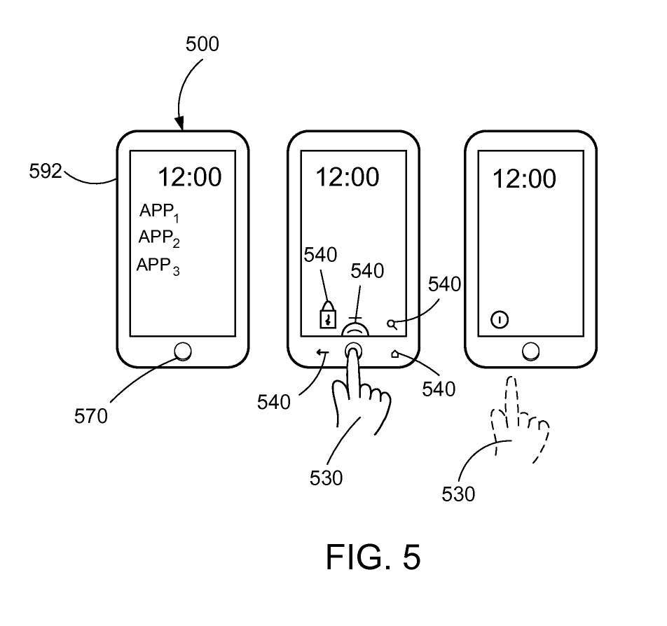

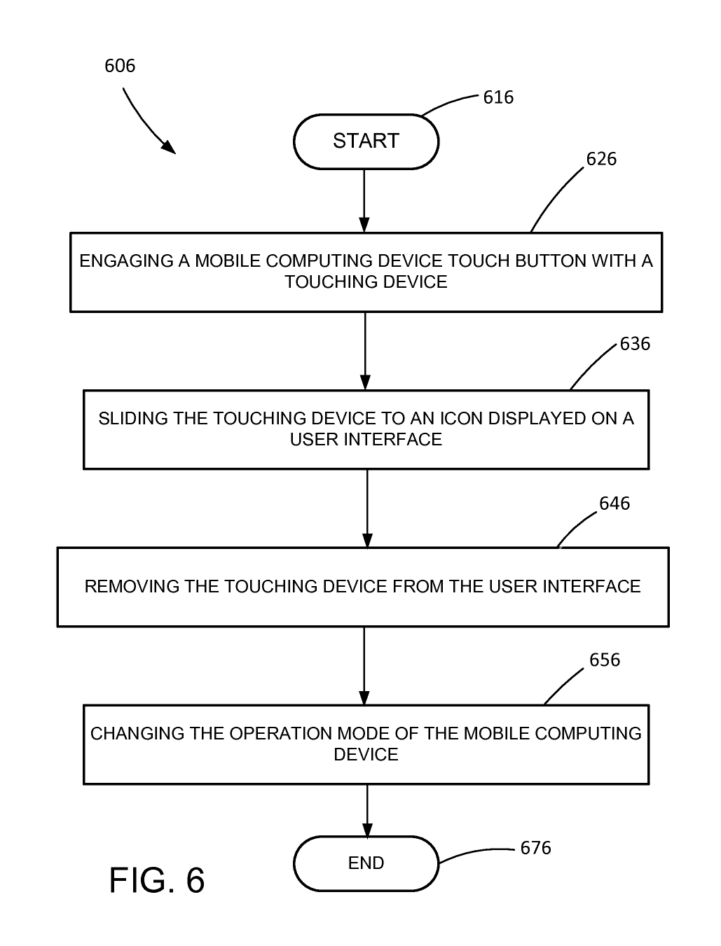

Turning now to FIG. 4, seen is a device 400 in a power-down mode 482, where a single-gesture is performed to power-up the device, unlock the user interface 410, placing the mobile computing device 400 in a wake-up mode 492. In such an embodiment, and as seen with mobile computing device 400A, upon the touching device 430 engaging the touch button 420 in a power-down mode 482, the touch button may be engaged for a time at least as great as the predetermined period, as seen with mobile computing device 400B. When the mobile computing device 400C reaches full power-up mode 472, the user interface 410 of mobile computing device 400C may be locked. At this point, and before the touching device 430 is lifted from the mobile computing device 430, the touching device 430 is slid along the direction 450 to the icon 440. Upon reaching the icon 440, the touching device 430 is removed and the user interface 410 is unlocked, as seen with mobile computing device 400E.

Turning now to FIG. 5, seen is a mobile computing device 500 in a wake-up mode 592. Upon pressing the touch button 520 with the touching device 530, one or more icons 540 may be displayed. It is contemplated that the terms “press” or “pressing” may be interchanged with the terms “engage” or “engaging”, respectively. In one embodiment, a user may engage a function associated with one of the icons 540 as displayed in FIG. 5 or in any other figure by sliding the touching device along the mobile computing device to the icon 540 and upon the touching device being located at the icon 540, removing the touching device from the mobile computing device. Functions associated with the icons include a home function, a back function, a lock function, a search function, and a menu function. If the touching device is removed from the mobile computing device 500, the icons may be removed from the display.

Another embodiment of the invention may comprise a mobile computing system. One mobile computing system may comprise the mobile computing device 100 described in reference to FIGS. 1-5. The mobile computing system may comprise a means for engaging the touch button 120 on the mobile computing device 100 with a touching device 130. The system may further comprise a means for sliding the touching device 130 from the touch button 120 to the user interface 110. The system may further comprise a means for changing an operation mode of the mobile computing device 100. For example, upon removing the touching device 130 from the icon 540, the operation mode may be modified. In one embodiment, changing an operation mode of the mobile computing device 100 may comprise changing from at least one of stand-by mode 102, a wakeup mode 192, and a power down mode 382 to at least one other of the stand-by mode 102, wakeup mode 192, and power down mode 382.

Turning now to FIG. 6, seen is a method 606 of changing an operation mode of a mobile computing device such as, but not limited to, the mobile computing device 100 seen in FIG. 1. The method may start at 616 and at 626 the method 606 comprises engaging a mobile computing device touch button 120 with a touching device 130. At 636 is the method step of sliding the touching device to an icon 140 displayed on a user interface 110, while at 646 is the method step of removing the touching device 130 from the user interface 110. At 656 is the method step of changing the operation mode of the mobile computing device 100. In one method 606, sliding the touching device 130 to an icon 140 displayed on a user interface 110 may comprise sliding the touching device 130 from the touch button 120 along a mobile computing device top surface 180. Furthermore, engaging mobile computing device touch button 130 with a touching device comprises pressing a mobile computing device button located on a top surface 180 of a mobile computing device 100.

One method 606 may further comprise changing the icon from a first icon 340′ to a second icon 340″ before sliding the touching device 330 to the icon 340 displayed on the user interface 310. One or more embodiments may comprise a first icon adapted to lock the mobile computing device, a second icon adapted to display a home user interface screen, a third icon adapted to return the user to the previous screen, a fourth icon adapted to display a menu, and a fifth icon adapted to provide a search function.

One embodiment of the invention may further comprise a non-transitory, tangible computer readable storage medium, encoded with processor readable instructions to perform a method of changing a mobile computing device mode of operation. One method may comprise engaging a touch button on a mobile computing device, the touch button being located on a top surface of a mobile computing device, sliding a finger from the touch button to an icon displayed on a mobile computing device user interface, removing the finger from the user interface, and changing the mobile computing device from a first mode of operation to a second mode of operation. It is contemplated that engaging a touch button may comprise pressing and releasing the touch button, while sliding a finger from the touch button to an icon displayed on a mobile computing device user interface may comprise sliding the finger from the touch button after engaging the touch button before removing the lifting the finger off the touch button. Furthermore, the method of changing a mobile computing device mode of operation may comprise changing the icon from a first icon to a second icon before sliding a finger from the touch button to an icon displayed on a mobile computing device user interface.

Turning now to FIG. 4B, shown is a diagrammatic representation of one embodiment of a machine in the exemplary form of the computing device 400 within which a set of instructions for causing a device to perform any one or more of the aspects and/or methodologies of the present disclosure to be executed. The elements identified by the reference numerals associated with FIG. 4B are different from the elements identified by the reference numerals associated with FIGS. 1-4 and FIGS. 5, 6 and are differentiated from these figures by using a “*” with each of the reference numerals.

Computing device 400* includes the processor 424*, which communicates with the memory 422* and with other components, via the bus 415*. Bus 415* may include any of several types of bus structures including, but not limited to, a memory bus, a memory controller, a peripheral bus, a local bus, and any combinations thereof, using any of a variety of bus architectures.

Memory 422* may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 426* (BIOS), including basic routines that help to transfer information between elements within computing device 400*, such as during start-up, may be stored in memory 422*. Memory 422* may also include (e.g., stored on one or more machine-readable media) instructions (e.g., software) 425*, the instructions 425* embodying any one or more of the aspects and/or methodologies of the present disclosure. In another example, memory 422* may further include any number of program modules including, but not limited to, an operating system, one or more application programs, other program modules, program data, and any combinations thereof.

Computing device 400* may also include a storage device 440*. Examples of a storage device (e.g., storage device 440*) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 440* may be connected to bus 415* by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 440* may be removably interfaced with computing device 400* (e.g., via an external port connector (not shown)). Particularly, storage device 440 and an associated machine-readable medium 435* may provide nonvolatile and/or volatile storage of machine-readable instructions, data structures, program modules, and/or other data for computing device 400*. In one example, instructions 425* may reside, completely or partially, within machine-readable medium 435*. In another example, instructions 425* may reside, completely or partially, within processor 424*.

Computing device 400* may also include an input device 490*. In one example, a user of computing device 400* may enter commands and/or other information into computing device 400* via input device 490*. Examples of an input device 490 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 490* may be interfaced to bus 415* via any of a variety of interfaces (not shown) including, but not limited to, a serial interface, a parallel interface, a game port, a USB interface, a FIREWIRE interface, a direct interface to bus 415*, and any combinations thereof.

A user may also input commands and/or other information to computing device 400 via storage device 440* (e.g., a removable disk drive, a flash drive, etc.) and/or a network interface device 445*. A network interface device, such as network interface device 445* may be utilized for connecting computing device 400* to one or more of a variety of networks, such as network 430*, and one or more remote devices 430* connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 432*, may employ a wired and/or a wireless mode of communication. In general, any network topology may be used. Information may be communicated to and/or from computing device 400* via network interface device 445*.

Computing device 400* may further include a video display adapter 460* for communicating a displayable image to a display device, such as display device 465*. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computing device 400* may include one or more other peripheral output devices including, but not limited to, an audio speaker, a printer, and any combinations thereof. Such peripheral output devices may be connected to bus 415 via a peripheral interface 470*. Examples of a peripheral interface include, but are not limited to, a serial port, a USB connection, a FIREWIRE connection, a parallel connection, and any combinations thereof. In one example an audio device may provide audio related to data of computing device 400* (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 465*. Accordingly, a digitizer may be integrated with display device 465*, or may exist as a separate device overlaying or otherwise appended to display device 465*.

For example, the medium 435* may comprise a non-transitory, tangible computer readable storage medium, encoded with processor readable instructions to perform a method of optimizing HTTP requests. One such method may comprise determining a file size for an object being sought by each HTTP request, determining a file type for the object being sought by each HTTP request, sending a HTTP request for at least one first file type object, and sending a HTTP request for at least one second file type object after sending the HTTTP request for the at least one first file type object.

It is further contemplated that the medium 435*, encoded with processor readable instructions to perform a method of optimizing HTTP requests may comprise determining a file size for the object being sought by each HTTP request and determining a file type for the object being sought by each HTTP request. Furthermore, a HTTP request may be sent for at least one first file type object a HTTP request may be sent for at least one second file type object after sending the HTTTP request for the at least one first file type object.

The medium 435* may further comprise receiving the at least one first type object before receiving the at least one second file type object. Furthermore, sending a HTTP request for at least one first file type object may comprise sending a plurality of HTTP requests for at least one first file type object. The plurality of HTTP requests may comprise a first HTTP request for a first file type object having a first file size and at least one second HTTP request for a second file type object having a second file size being sent after the first HTTP request, wherein the second file size is greater than the first file size. Additionally, the at least one first file type object may comprise a JavaScript and a cascading style sheet and the at least one second file type object may comprise an image.

In conclusion, embodiments of the present invention provide for a single gesture to change a mobile computing device mode of operation. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A mobile computing device comprising,
a user interface; and
a touch button, wherein, a mobile computing device operation is adapted to occur upon,
the touch button being engaged with a touching device, and
the touching device sliding to the user interface prior to removing the touching device from the mobile computing device.

2. The mobile computing device of claim 1 wherein, the user interface is a screen, the screen comprising a first planar surface.

3. The mobile computing device of claim 2 further comprising,
a top surface, the top surface comprising a second planar surface, the second planar surface being located on a substantially similar plane as the first planar surface; and wherein,
the touch button comprises,
an upper portion edge, the upper portion edge comprising a third planar surface, the third planar surface substantially similar to the second planar surface; and
a lower portion edge, wherein, the lower portion edge comprises at least one of a raised and a lowered edge, the at least one of a raised a lowered edge comprising a fourth planar surface, the fourth planar surface being different than the third planar surface.

4. The mobile computing device of claim 3, wherein the touch button is substantially surrounded by the top surface.

5. The mobile computing device of claim 1 wherein,
the user interface comprises an icon;
the mobile computing device operation comprise changing an operating mode of the mobile computing device;
engaging the touch button with a touching device comprises pressing the button with a finger; and
sliding the touching device to the user interface comprises,
sliding the finger from the touch button to the icon, and
lifting the finger from the icon.

6. The mobile computing device of claim 5 wherien,
the icon comprises a first icon; and further comprising,
changing the first icon to a second icon upon pressing the button with a finger.

7. A computing system comprising,
means for engaging a touch button on a mobile computing device with a touching device;
means for sliding the touching device from the touch button to a mobile computing device user interface; and
means for changing an operation mode of the mobile computing device.

8. The computing system of claim 7, wherein the means for changing an operation mode of the mobile computing device comprises changing from at least one of stand-by mode, a wakeup mode, and a power down mode to at least one other of the stand-by mode, wakeup mode, and power down mode.

9. The computing system of claim 8 wherein, means for sliding a touching device from the touch button to a mobile computing device user interface comprises sliding a finger from the touch button to an icon displayed on the user interface.

10. The computing system of claim 8, further comprising, means for changing an icon displayed on the user interface from a first icon to a second icon.

11. A method of changing an operation mode of a mobile computing device comprising,
engaging a mobile computing device touch button with a touching device;
sliding the touching device to an icon displayed on a user interface;
removing the touching device from the user interface; and
changing the operation mode of the mobile computing device.

12. The method of claim 11 wherein sliding the touching device to an icon displayed on a user interface comprises sliding the touching device from the touch button along a mobile computing device top surface.

13. The method of claim 11 wherein, engaging mobile computing device touch button with a touching device comprises pressing a mobile computing device button located on a top surface of a mobile computing device.

14. The method of claim 11 further comprising, changing the icon from a first icon to a second icon before sliding the touching device to an icon displayed on a user interface.

15. The method of claim 11, wherein, changing the operation mode of the mobile computing device comprises changing from one of a wakeup mode, standby mode, power-up mode and power-down mode to another of the wakeup mode, standby mode, power-up mode and power-down mode.

16. The method of claim 11 wherein, the icon comprises at least one of,
a first icon adapted to lock the mobile computing device;
a second icon adapted to display a home user interface screen;
a third icon adapted to return the user to the previous screen;
a fourth icon adapted to display a menu; and
a fifth icon adapted to provide a search function.

17. A non-transitory, tangible computer readable storage medium, encoded with processor readable instructions to perform a method of changing a mobile computing device mode of operation, the method comprising,
engaging a touch button on a mobile computing device, the touch button being located on a top surface of a mobile computing device;
sliding a finger from the touch button to an icon displayed on a mobile computing device user interface;
removing the finger from the user interface; and
changing the mobile computing device from a first mode of operation to a second mode of operation.

18. The non-transitory, tangible computer readable storage medium of claim 17, wherein, engaging a touch button comprises pressing and releasing the touch button.

19. The non-transitory, tangible computer readable storage medium of claim 17, wherein, sliding a finger from the touch button to an icon displayed on a mobile computing device user interface comprises sliding the finger from the touch button after engaging the touch button before removing the lifting the finger off the touch button.

20. The non-transitory, tangible computer readable storage medium of claim 17 further comprising, changing the icon from a first icon to a second icon before sliding a finger from the touch button to an icon displayed on a mobile computing device user interface.
